(19) United States
(12) Patent Application Publication
(10) Pub. No.: US 2026/0197019 A1
(43) Pub. Date: Jul. 9, 2026

(54) RADIO FREQUENCY RECEIVING UNIT AND METHOD OF SIGNAL RECEPTION THEREOF

(71) Applicant: SAMSUNG ELECTRONICS CO., LTD., SUWON-SI (KR)

(72) Inventors: Jia Luo, Suzhou (CN); Hede Peng, Suzhou (CN)

(21) Appl. No.: 19/049,040

(22) Filed: Feb. 10, 2025

(30) Foreign Application Priority Data
Jan. 6, 2025 (CN) 202510024986.4

(51) Int. Cl. H04B 1/12; H04B 1/10; H04B 1/16

(52) U.S. Cl. CPC H04B 1/12; H04B 1/1607; H04B 2001/1054

(57) ABSTRACT

The present disclosure provides a radio frequency receiving unit and a method of signal reception thereof, in particular, a radio frequency receiving unit is provided. The radio frequency receiving unit comprises a plurality of signal processing paths, at least one receiving port, each of the at least one receiving port being configured to receive a received signal having any frequency within a full bandwidth encompassing a predetermined range of frequencies, a frequency detection unit configured to detect a frequency band to which the received signal belongs, and a control unit configured to control routing, based on the detected frequency band, of the received signal to a corresponding signal processing path for processing.

### CROSS REFERENCE TO RELATED APPLICATIONS

This application is related to and claims priority to China Patent Application No. 202510024986.4, filed in the China National Intellectual Property Administration on Jan. 6, 2025, the entire content of which is incorporated by reference herein.

### TECHNICAL FIELD

The present disclosure relates to a field of communication technology, and more particularly to a radio frequency receiving unit and a method of signal reception thereof.

### DISCUSSION OF RELATED ART

In today's world economy, the demand for uploading and downloading of multimedia, Internet, a short video and the like is accelerating, and the demand for uplink and downlink throughput from/to users is surging, while the spectrum resources are limited. The increasing demand for the throughput of mobile terminal users has led to many carrier aggregation (CA)/Long Term Evolution (LTE) and New Radio (NR) Dual-Connectivity (EUTRA NR Dual-Connectivity, ENDC)/NR CA combinations required by operators in various countries and regions around the world. For instance, 7CA/9CA combinations between “low frequency”, “intermediate frequency”, and “high frequency” are realized within limited hardware resources, resulting in complex design of radio frequency (RF) front-end architecture.

Bandwidth of a current receiving (Rx) low noise amplifier integrated into a radio frequency transceiver tends to support only a portion of the frequency band, for example, a low frequency (e.g., 700 MHz~960 MHz), a medium-high frequency (e.g., 1.7 GHz~3 GHz), and an ultra-high frequency (e.g., 3.3 GHz~4.2 GHz), respectively. Since each receiving port does not achieve full bandwidth coverage from the low frequency to the ultra-high frequency and the number of hardware Rx ports is limited, the front-end design employs more RF devices and switches to achieve more CA/ENDC/NR CA combinations. This not only makes the design more complex and difficult, but also fails to maximize the CA/ENDC/NR CA combinations.

### SUMMARY

Embodiments of the present disclosure provide a radio frequency (RF) receiving unit and a method of signal reception thereof that may solve some or all of the above problems.

According to a first aspect of the disclosure, a radio frequency (RF) receiving unit is provided, comprising: a plurality of signal processing paths; at least one receiving port, each of the at least one receiving port being configured to receive a received signal having any frequency within a full bandwidth encompassing a predetermined range of frequencies; a frequency detection unit configured to detect a frequency band, within the full bandwidth, to which the received signal belongs; and a control unit configured to control routing, based on the detected frequency band, of the received signal to a corresponding signal processing path among the signal processing paths for processing.

In various options:

The frequency detection unit is configured to indicate the detected frequency band to the control unit.

The RF receiving unit further comprises a switch module, wherein the control unit is configured to: receive the indication of the detected frequency band from the frequency detection unit and control, based on the detected frequency band, the switch module to switch the received signal to the corresponding signal processing path for processing.

The RF receiving unit may further comprise a low noise amplifier module configured for operation over the full bandwidth, which comprises low noise amplifiers optimized for different respective frequency bands, wherein each of the plurality of the signal processing paths is provided with a low noise amplifier corresponding to at least one of the frequency bands.

The control unit may be configured to control routing, based on the detected frequency band, of the received signal to the signal processing path provided with the low noise amplifier corresponding to the frequency band for processing.

The radio frequency receiving unit may further comprise peripheral circuitry which comprises one or more full bandwidth receiving antennas, wherein each of the at least one receiving port is connected to the one or more full bandwidth receiving antennas to receive the received signal.

According to another aspect of the disclosure, a method of signal reception, performed by the radio frequency receiving unit summarized above, includes: receiving, by the at least one receiving port, a received signal; detecting, by the frequency detection unit, a frequency band to which the received signal belongs; and routing the received signal to a corresponding signal processing path for processing, under control of the control unit, based on the detected frequency band.

According to another aspect of the disclosure, a communication node includes: a radio frequency receiving unit; and a processor coupled to the radio frequency receiving unit and configured to perform the method of signal reception as described above.

According to another aspect of the disclosure, a computer-readable storage medium is provided, wherein a computer program is stored thereon, the program when executed implementing the method of signal reception as described above.

The technical solutions provided according to embodiments of the disclosure bring at least the following beneficial effects: each receiving port of the radio frequency receiving unit may realize the reception of the full bandwidth signal, and the selection and configuration of the receiving port are more flexible. Since it is no longer necessary that each receiving port can only receive the signal of a fixed frequency band, the design complexity of the radio frequency front-end and insertion loss of the path are reduced, and the reception capability of the radio frequency path is improved. In addition, the radio frequency receiving unit of the present disclosure may achieve the maximizing demand for CA/ENDC/NR CA by different operators in different regions of the world, which improves downlink throughput and enhances user experience.

It should be understood that the above general description and the later detailed description are examples and explanatory only and do not limit the present disclosure.

### BRIEF DESCRIPTION OF THE DRAWINGS

The accompanying drawings herein are incorporated into and form part of the specification, illustrate embodiments consistent with the disclosure, which are used in conjunction with the specification to explain the principles of the disclosure and do not constitute an undue limitation of the disclosure.

FIG. 1 illustrates a schematic block diagram of an interior of a conventional radio frequency transceiver.

FIG. 2 illustrates signals being inputted to receiving ports of a conventional radio frequency transceiver in a carrier aggregation scenario.

FIG. 3 illustrates a conventional receiving scheme of adding peripheral paths and devices.

FIG. 4 illustrates a schematic block diagram of an interior of a radio frequency receiving unit according to embodiments of the present disclosure.

FIG. 5 illustrates a schematic diagram of a single path within a radio frequency receiving unit according to embodiments of the present disclosure.

FIG. 6 illustrates another schematic diagram of a single path within a radio frequency receiving unit according to embodiments of the present disclosure.

FIG. 7 illustrates a schematic diagram of multiple paths within a radio frequency receiving unit according to embodiments of the present disclosure.

FIG. 8 illustrates a schematic diagram of a radio frequency transceiver including peripheral circuitry according to embodiments of the present disclosure.

FIG. 9 illustrates signals being inputted to receiving ports of a radio frequency transceiver in a carrier aggregation scenario according to embodiments of the present disclosure.

FIG. 10 illustrates a flowchart of a method of signal reception according to embodiments of the present disclosure.

FIG. 11 illustrates a block diagram of a communication node according to embodiments of the present disclosure.

### DETAILED DESCRIPTION

To enable a person of ordinary skill in the art to better understand the inventive concepts and technical solutions of the disclosure, embodiments of the disclosure will be clearly and completely described below in conjunction with the accompanying drawings.

It should be noted that the terms “first”, “second”, etc. in the specification and claims of the disclosure and the accompanying drawings above are used to distinguish similar objects rather than to describe a particular order or sequence. It should be understood that data so distinguished may be interchanged, where appropriate, so that embodiments of the disclosure described herein may be implemented in an order other than those illustrated or described herein. Embodiments described in the following examples do not represent all embodiments that are consistent with the disclosure. Rather, they are only examples of devices and methods that are consistent with some aspects of the disclosure, as detailed in the appended claims.

It should be noted herein that “at least one of the several items” in this disclosure includes “any one of the several items”, “any combination of the several items” and “all of the several items” the juxtaposition of these three categories. For example, “including at least one of A and B” includes the following three juxtapositions: (1) including A; (2) including B; (3) including A and B. Another example is “performing at least one of operation one and operation two”, which means the following three juxtapositions (1) performing operation one; (2) performing operation two; (3) performing operation one and operation two.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

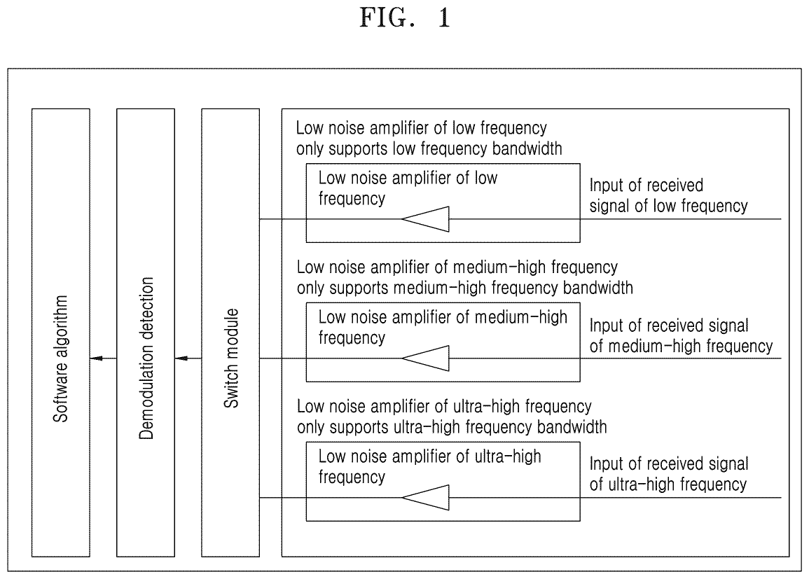

FIG. 1 illustrates a schematic block diagram of an interior of a conventional radio frequency transceiver. Referring to FIG. 1, the radio frequency transceiver (or the radio frequency receiver included therein) includes three receiving ports and also includes a low noise amplifier of low frequency, a low noise amplifier of medium-high frequency, and a low noise amplifier of ultra-high frequency. The low noise amplifier of the low frequency may support just the low frequency bandwidth and may process the low frequency signal. The low noise amplifier of the medium-high frequency may support just the medium-high frequency bandwidth and may process the medium-high frequency signal, and the low noise amplifier of the ultra-high frequency may support just the ultra-high frequency bandwidth and may process the ultra-high frequency signal. After the three receiving ports of the radio frequency transceiver receive the input of the low frequency signal, the input of the medium-high frequency signal and the input of the ultra-high frequency signal respectively, the low frequency signal is transmitted to the low noise amplifier of the low frequency for processing, the medium-high frequency signal is transmitted to the low noise amplifier of the medium-high frequency for processing, and the ultra-high frequency signal is transmitted to the low noise amplifier of the ultra-high frequency for processing. The processed signals, after being through a subsequent switch module (i.e. SW Box) (an optional module), are then inputted to a demodulation detection module and a software algorithm module to realize the demodulation of the received signals.

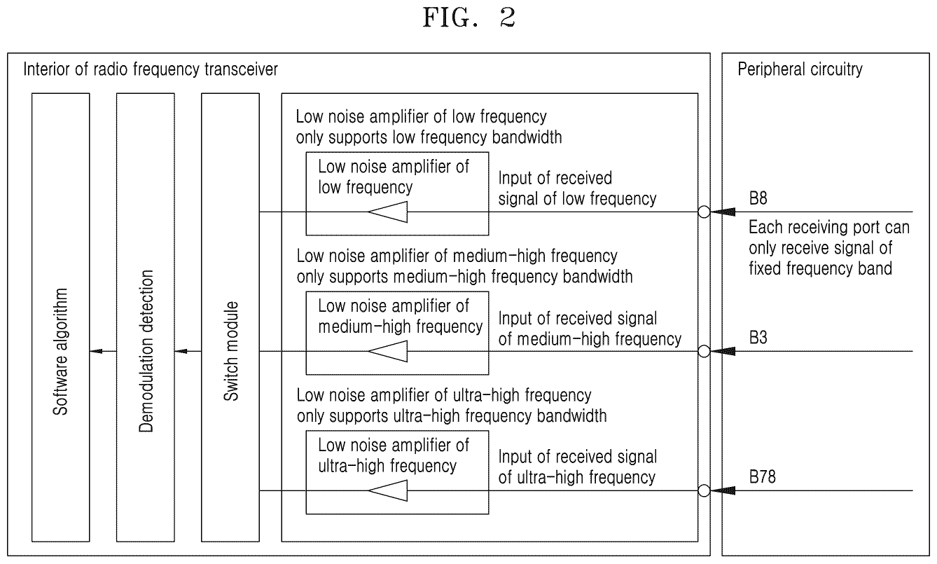

FIG. 2 illustrates signals being inputted to receiving ports of a conventional radio frequency transceiver in a carrier aggregation scenario.

Referring to FIG. 2, in a carrier aggregation (CA) scenario, for example, in the case of CA: B8-B3-B78 for the carrier aggregation, the received signal of the frequency band B8 (960 MHz) may only be input from the receiving port of the low frequency, the received signal of the frequency band B3 (1800 MHz) may only be input from the receiving port of the medium-high frequency, and the received signal of the frequency band B78 (3300 MHz-3800 MHz) may only be input from the receiving port of the ultra-high frequency.

In the current radio frequency transceiver (or the radio frequency receiver included therein), each receiving port may only receive the signal of the frequency band in a fixed frequency range and may not realize the full bandwidth coverage from the low frequency to the ultra-high frequency, and since the frequency band of the received signal at the receiving port is fixed, peripheral circuitry needs to be designed in accordance with the rules of the port of the radio frequency transceiver, which increases the complexity of the peripheral circuitry, and the wiring of the flexible printed circuit board(PCB) is not flexible.

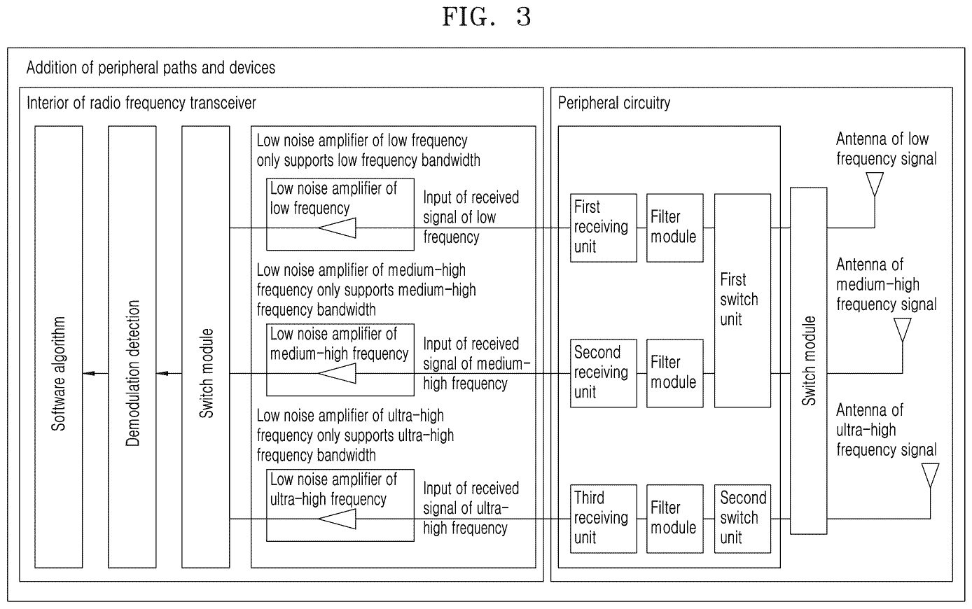

FIG. 3 illustrates the conventional receiving scheme of adding peripheral paths and devices.

Referring to FIG. 3, in the prior art, a switch module may be added to the periphery of the radio frequency transceiver (or the radio frequency receiver included therein), and the signal of the preset frequency band, after being switched to different receiving paths (which may include a filter module and a receiving unit) for different frequency bands at the periphery, then may be input through the corresponding receiving port of the radio frequency transceiver, respectively. This scheme does not change the internal architecture and circuitry of the radio frequency transceiver and each receiving port of the radio frequency transceiver in this scheme can only input the signal of the frequency band in a fixed frequency range. Furthermore, if, for each frequency, band processing of the each frequency band is achieved by adding the switch, the filter module, and the receiving unit, it may significantly increase the cost, and greatly increase the complexity of the system, lead to the inflexible antenna design scheme, as well as degradation of radio frequency performance and impact on user experience due to the increase in wiring loss in each path.

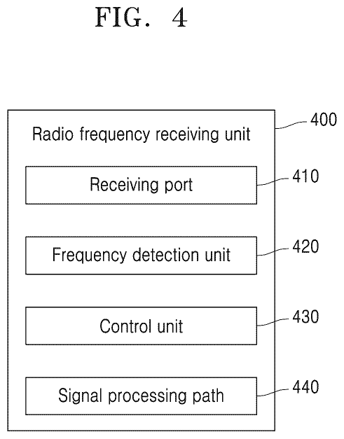

To address the above issues, the present disclosure achieves full bandwidth reception of each receiving port by optimizing the internal architecture of the radio frequency transceiver (or a radio frequency receiving unit) which integrates a frequency detection module and a switch module inside to switch to the signal processing path. The interior of the radio frequency transceiver may refer to the interior of a chip (e.g., a chip of the radio frequency transceiver), and the receiving port may refer to a connection point of the chip, and the peripheral circuitry may be the circuitry of the periphery built around the interior of the radio frequency transceiver, wherein the peripheral circuitry may include: a power amplifier (part of the transmitter of the transceiver), a filter, and an antenna, etc. Both the interior of the radio frequency transceiver and the peripheral circuitry may be implemented in the form of a radio frequency integrated circuit (RFIC). The radio frequency receiving unit and the method of signal reception thereof according to the present disclosure are described specifically below with reference to FIGS. 4 through 11 of the accompanying drawings.

The radio frequency receiving unit (“receiver”) of the present disclosure may be a receiver portion of a radio frequency transceiver of an apparatus with a communication function, or a portion of an apparatus with the communication function that separately realizes signal reception, and the present disclosure does not limit this. Further, the apparatus with the communication function may include: a mobile terminal (such as a smart phone, a cellular phone, a video phone, etc.), a wearable device (such as, smart glasses, a head-mounted display (HMD), an e-clothing, an e-bracelet, an e-necklace, an e-accessory, an e-tattoo, or a smart watch, etc.), a sensor, a mobile medical device, an apparatus of internet of things, a tablet PC, a desktop type, a laptop type, a handheld type computers, a laptop, a netbook, a personal digital assistant (PDA), an augmented reality (AR)/a virtual reality (VR), etc. The apparatus with the communication function may also include a base station in a 5G system, a base station (BTS) in global system for mobile communications (GSM) system or a code division multiple access (CDMA) system, a base station (NodeB) in a wideband CDMA (WCDMA) system, an evolved base station (eNB) in a LTE system, an access point (AP), a relay station, a radio network controller (RNC), a base station controller (BSC), a transceiver function (TF), a wireless router, a wireless transceiver, and so on, the present disclosure is not limited thereto.

FIG. 4 illustrates a schematic block diagram of an interior of a radio frequency receiving unit according to embodiments of the present disclosure.

Referring to FIG. 4, the radio frequency receiving unit (i.e., the radio frequency receiver) 400 may include: at least one receiving port 410, a frequency detection unit 420, a control unit 430, and a plurality of signal processing paths 440. Wherein each of the at least one receiving port is capable of receiving a full bandwidth signal, the frequency detection unit may detect a frequency band to which a signal received by the at least one receiving port belongs, the control unit may control routing (“inputting”), based on the detected frequency band, of the received signal to a corresponding signal processing path for processing.

In embodiments of the present disclosure, the RF receiving unit may include at least one receiving port, and each receiving port may realize reception of a “full bandwidth signal”. Herein, a “full bandwidth” may encompass a predetermined range of frequencies (e.g., modulated carriers for data/control/pilot signal communication) for which the RF receiving unit is designed to receive and demodulate sufficiently to achieve a requisite communication performance. A “full bandwidth signal” may be a received signal having any frequency within the full bandwidth. The range of frequencies of the full bandwidth may encompass multiple frequency bands that may include segregated, overlapping or and/or adjacent frequency bands. As mentioned earlier, it is desirable to design the RF receiving unit with capability to receive signals required by operators in various countries and regions around the world, which may be within different respective frequency bands, e.g., a “low frequency band”, a “medium-high frequency band” and an “ultra-high frequency band”. The signal of any frequency band within the full bandwidth may be input from the receiving port without the need to be input through a fixed receiving port, which flexibly realizes the free configuration of the receiving port.

In embodiments of the present disclosure, the frequency detection unit may be connected to each of the at least one receiving port and detect the frequency of the signal received at each receiving port, thereby determining which band the received signal is within. The frequency detection unit may be designed to detect signals having characteristics expected in a mobile communication system such as one compatible with an LTE (4G) or NR (5G) protocol. For instance, the frequency detection unit may be configured to determine whether and where pilot signals (or control channels) having received signal strength (RSSI) above a predetermined threshold exist over the full frequency band. In this manner, when the mobile terminal or the like, of which the receiving unit is part of, is first turned on, the frequency detection unit may detect base station signals to determine the protocol, e.g., 2G, 3G, 4G, etc., of communication signals in the region to use. To this end, the frequency detection unit may detect the frequency of the signal using a variety of methods. Some example methods include: (i) a counting method which calculates the frequency of the signal by calculating the number of periods over a period of time; (ii) a phase synergy method which calculates the frequency by comparing the phase transitions of two signals (iii) a phase shift method which measures the frequency by varying the phase difference of the signal, and (iv) a frequency meter method which measures the frequency of the signal through a specialized frequency meter. Note that the frequency detection unit may include one or more of its own low noise amplifiers to amplify the input signal to a sufficient level and signal to noise level to perform an accurate frequency detection. It should be understood that the above methods of detecting frequency of the frequency detection unit are only examples, and the present disclosure is not limited thereto.

According to embodiments of the present disclosure, the frequency detection unit may indicate (provide information on) the detected frequency band to the control unit.

In embodiments of the present disclosure, the frequency detection unit may be connected to the control unit and indicate the detected frequency band to which the received signal belongs to the control unit. After receiving the indication of the detected frequency band from the frequency detection unit, the control unit may control routing, based on the detected frequency band, of the received signal to a corresponding (or different) signal processing path for processing.

In embodiments of the present disclosure, the plurality of the signal processing paths may process the received signals of the same or different frequency bands, and the plurality of the signal processing paths may process the received signals covering the full bandwidth. For example, in the case that three signal processing paths are included, the three signal processing paths may separately process, for example, the low frequency signal, the medium-high frequency signal, and the ultra-high frequency signal. In the case that five signal processing paths are included, the number of the paths for processing the low frequency signal and the number of the paths for processing the medium-high frequency signal may be two respectively, while the other signal processing path may process the ultra-high frequency signal. In addition, frequency band ranges which may be processed by the plurality of the signal processing paths may be specified specifically, for example, the frequency band range which may be processed by the signal processing path 1 is 2.2 GHz-4.0 GHz, and when the frequency detection unit detects that the frequency of the received signal falls into this frequency band range, the control unit may cause the received signal to be routed into the signal processing path 1.

Herein, the number of the plurality of the signal processing paths and the specific types and range values of the frequency band for processing signals are only examples, and the present disclosure is not limited thereto. Moreover, the structure of the above-described radio frequency receiving unit is also only exemplary, and the present disclosure is not limited thereto.

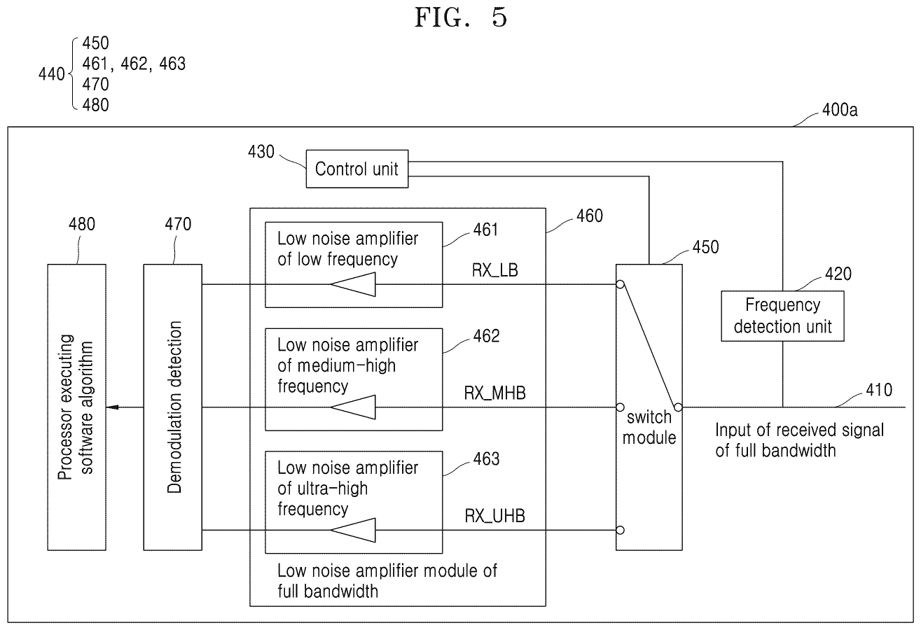

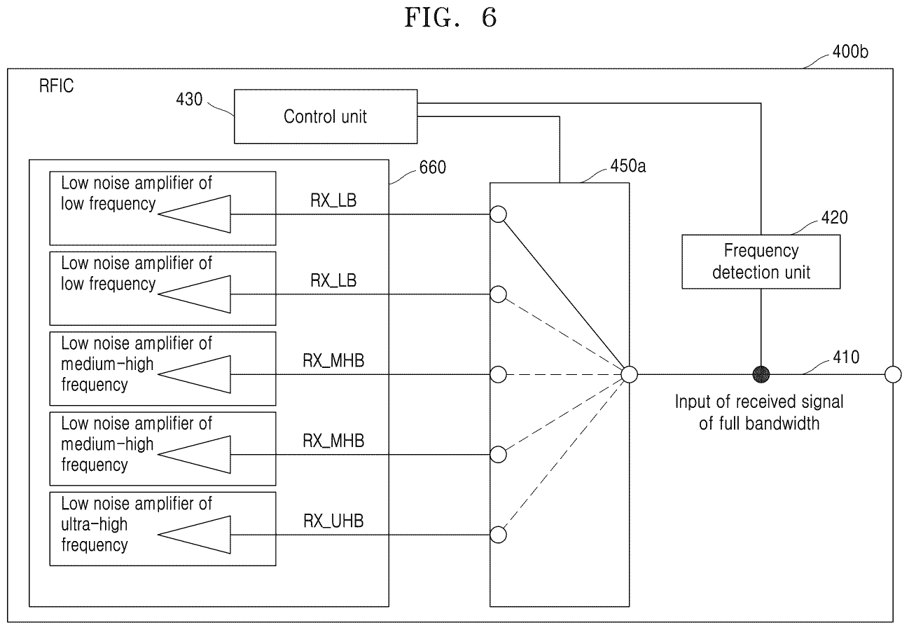

FIG. 5 illustrates a schematic diagram of a single path inside a radio frequency receiving unit 400a (an example of the RF receiving unit 400) according to embodiments of the present disclosure, and FIG. 6 illustrates another schematic diagram of a single path inside a radio frequency receiving unit 400b according to embodiments of the present disclosure.

Referring to FIGS. 5 and 6, the radio frequency receiving unit 400a and 400b may include: at least one receiving port 410, a frequency detection unit 420, a control unit 430, a plurality of signal processing paths 440, and a switch module 450. Only one receiving port is shown in both FIGS. 5 and 6, but the number of radio frequency receiving unit ports of the present disclosure may also be provided in plural. Three signal processing paths 440 are shown in FIG. 5 and the processed signals are sequentially inputted to a demodulation detection module 470 and a processor 480 executing a software algorithm module to achieve the demodulation of the received signals, while five signal processing paths are shown in the radio frequency integrated circuit (RFIC) of FIG. 6. Each signal processing path 440 of FIG. 5 may be considered to include a routing path within the switch module 450, one of the low noise amplifiers (LNAs) 461, 462 or 463 of an LNA module 460, the demodulation/detection module 470, and the processor 480. Similarly, each signal processing path 440 of FIG. 6 may be understood to include a routing path within a switch module 450a, an LNA within an LNA module 660, the demodulation detection module 470 and the processor 480 (both not shown in FIG. 6).

In embodiments of the present disclosure, the receiving port is capable of receiving an input signal of full bandwidth, and the frequency detection unit may be connected to the receiving port and detect the frequency of the signal received at the receiving port, thereby determining which frequency band the signal received at the receiving port is. The frequency detection unit may be connected to the control unit and transmit the detected frequency band to which the received signal belongs to the control unit.

According to embodiments of the present disclosure, the radio frequency receiving unit may further include a switch module, wherein the control unit may receive the detected frequency band transmitted by the frequency detection unit, and control, based on the detected frequency band, the switch module to switch the received signal to the signal processing path corresponding to the frequency band for processing.

In embodiments of the present disclosure, it may be achieved by the switch module that the received signal is inputted to the corresponding signal processing path for processing. The control unit may also be connected to the switch module, and the control unit may control the switch module to switch the received signal to the signal processing path corresponding to the frequency band after receiving the detected frequency band transmitted by the frequency detection unit. The switch module may include one or more switches. Referring to FIGS. 5 and 6, in the case of one receiving port, the switch module may include, for example, one single-pole multi-throw switch. In the case that the frequency band to which the received signal belongs detected by the frequency detection unit is the low frequency, the control unit may control this single-pole multi-throw switch of the switch module to be connected to the signal processing path of the low frequency, so that the received signal as the low frequency signal is processed by the signal processing path of the low frequency.

It will be understood that the structure of the switch module described above is only exemplary, and the number of switches and the type of switches are only exemplary, and the present disclosure is not limited thereto.

According to embodiments of the present disclosure, the radio frequency receiving unit may further include a low noise amplifier module of full bandwidth which includes low noise amplifiers of different frequency bands (e.g., optimized at different respective frequency bands), wherein each of the plurality of the signal processing paths is provided with a low noise amplifier corresponding to at least one the frequency band.

In embodiments of the present disclosure, each of the plurality of the signal processing paths may be provided with a low noise amplifier corresponding to at least one frequency band, the low noise amplifiers may be low noise amplifiers of the same or different frequency bands, and all of the low noise amplifiers constitute the low noise amplifier module of full bandwidth. Each signal processing path is provided with the low noise amplifier corresponding to its processing frequency band, for example, the signal processing path processing the received signal of the low frequency (Rx_LB) (i.e., the signal processing path of the low frequency) may be provided with the low noise amplifier of the low frequency, and the signal processing path processing the received signal of the medium-high frequency (Rx_MHB) (i.e., the signal processing path of the medium-high frequency) may be provided with the low noise amplifier of the medium-high frequency, and the signal processing path processing the ultra-high frequency received signal (Rx_UHB) (i.e., the signal processing path of the ultra-high frequency) may be provided with the low noise amplifier of the ultra-high frequency. Referring to FIG. 5, three signal processing paths are included in FIG. 5, which consists of the signal processing path of the low frequency including the low noise amplifier of the low frequency, the signal processing path of the medium-high frequency including the low noise amplifier of the medium-high frequency, and the signal processing path of the ultra-high frequency including the low noise amplifier of the ultra-high frequency, wherein the three low noise amplifiers cover the full bandwidth and constitute the low noise amplifier module of full bandwidth, so that the three signal processing paths may process signals covering the full bandwidth. Referring to FIG. 6, five signal processing paths are included in FIG. 6, which consists of two signal processing paths of the low frequency including the low noise amplifiers of the low frequency, two signal processing paths of the medium-high frequency including the low noise amplifiers of the medium-high frequency, and one signal processing path of the ultra-high frequency including the low noise amplifier of the ultra-high frequency, wherein the five low noise amplifiers also cover the full bandwidth and constitute the low noise amplifier module of full bandwidth, so that the five signal processing paths may process signals covering the full bandwidth.

According to embodiments of the present disclosure, the control unit may control routing, based on the detected frequency band, of the received signal to the signal processing path provided with the low noise amplifier corresponding to the frequency band for processing. For example, the control unit may input the received signal to the signal processing path of low frequency provided with the low noise amplifier of the low frequency for processing in response to the detected frequency band being the low frequency, input the received signal to the signal processing path of medium-high frequency provided with the low noise amplifier of the medium-high frequency for processing in response to the detected frequency band being the medium-high frequency, and input the received signal to the signal processing path of ultra-high frequency provided with the low noise amplifier of the ultra-high frequency for processing in response to the detected frequency band being the ultra-high frequency.

In embodiments of the present disclosure, the control unit, after receiving an indication of the frequency band from the frequency detection unit, may control the switch module to input the received signal to the signal processing path provided with the low noise amplifier corresponding to the detected frequency band for demodulation of the received signal.

In embodiments of the present disclosure, the plurality of the signal processing paths may not only be the signal processing paths including the signal processing path of the low frequency, the signal processing path of the medium-high frequency, and the signal processing path of the ultra-high frequency to cover the full bandwidth, but also the signal processing paths including the signal processing path of the low frequency, the signal processing path of medium frequency, the signal processing path of high frequency and the signal processing path of the ultra-high frequency, and each of the signal processing paths of various frequency bands is provided with the low noise amplifier that supports the corresponding frequency band. Further, there may be an overlap between the frequency bands, for example, the plurality of the signal processing paths may also include the signal processing path of low-medium frequency, the signal processing path of the medium-high frequency, and the signal processing path of the ultra-high frequency, and each of which is provided with the low noise amplifier of the low-medium frequency, the low noise amplifier of the medium-high frequency, and the low noise amplifier of the ultra-high frequency, respectively, wherein the frequency bands of the signals processed by the signal processing path of the low-medium frequency and the signal processing path of the medium-high frequency may at least partially overlap. When the frequency of the received signal falls into the overlapping frequency band, the control unit may input the received signal into the signal processing path of the medium-low frequency or the signal processing path of the medium-high frequency, and when the frequencies of a plurality of received signals fall into the overlapping frequency band, the control unit may input two different received signals into the signal processing path of the medium-low frequency and the signal processing path of the medium-high frequency, respectively.

It should be understood that the number of the plurality of the signal processing paths and the specific types and range values of the frequency band for processing signals are only examples, and the present disclosure is not limited thereto. In addition, the structure of the above-described radio frequency receiving unit is also only exemplary, and the present disclosure is not limited thereto.

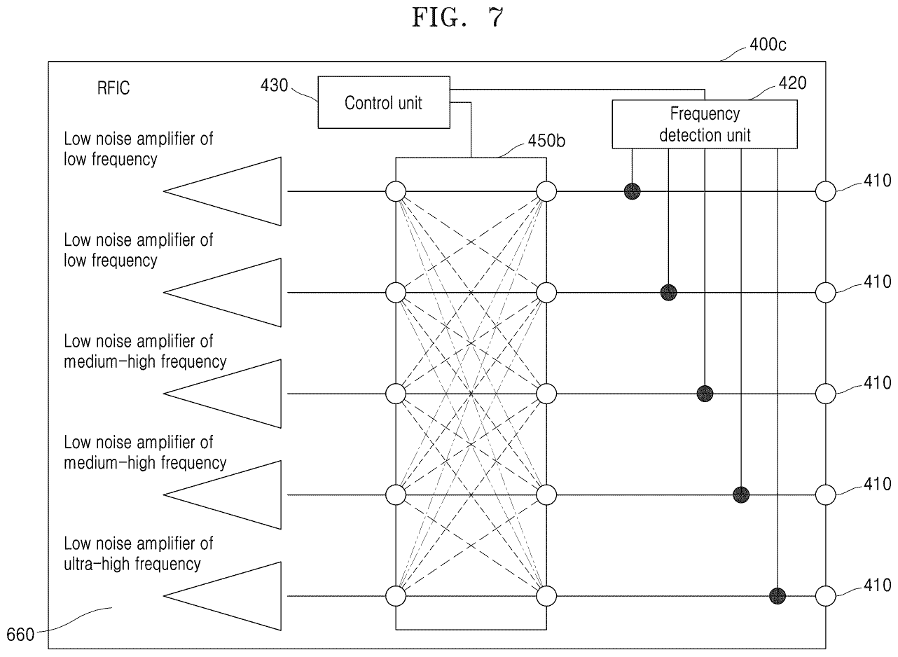

FIG. 7 is a schematic diagram of multiple paths inside a radio frequency receiving unit 400c according to embodiments of the present disclosure.

The radio frequency receiving unit 400c (the RFIC of the radio frequency receiving unit) may include a plurality of receiving ports 410, and the radio frequency receiving unit in which the number of receiving ports is five is illustrated in FIG. 7. Each of the five radio frequency receiving ports is capable of receiving an input of the full bandwidth signal, and the radio frequency receiving unit may support operations of a part of or all of the plurality of receiving ports. Here, the frequency detection unit 420 may be connected to each of the receiving ports and may detect the frequency of the signal received at each of the receiving ports to determine the frequency band to which it belongs. The frequency detection unit may feed back the information of the detected frequency band corresponding to the receiving port to the control unit 430 (i.e., “indicate the detected frequency band to the control unit”), and the control unit receiving the fed back frequency band information may control the switch module 450b to switch the signal received at the receiving port corresponding to the frequency band to the signal processing path provided with a low noise amplifier(in the low noise amplifier module 660) corresponding to the frequency band. In FIG. 7, the switch module may, for example, include a multi-pole multi-throw switch connected to five receiving ports correspondingly, and the switch module is connected to the corresponding signal processing path under the control of the control unit.

It should be understood that the structure of the switch module described above is only exemplary, and the number of switches and the types of switches are also only exemplary, and the present disclosure is not limited thereto.

According to embodiments of the present disclosure, the radio frequency receiving unit may further include peripheral circuitry which includes one or more full bandwidth receiving antennas, wherein each of the at least one receiving port is connected to the one or more full bandwidth receiving antennas to receive the full bandwidth signal.

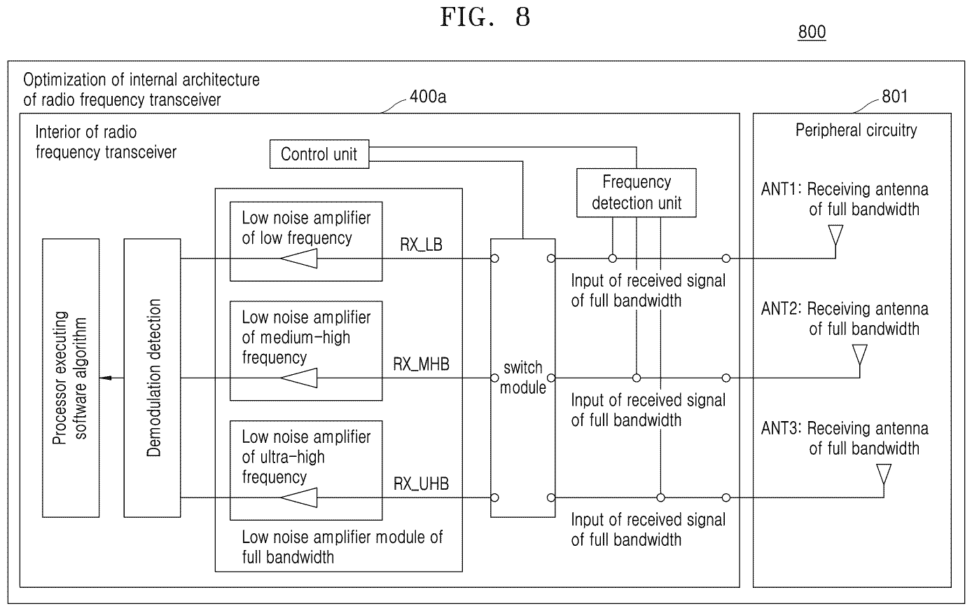

FIG. 8 illustrates a schematic diagram of a radio frequency transceiver 800 including peripheral circuitry 801 according to embodiments of the present disclosure.

Referring to FIG. 8, the interior of the radio frequency transceiver (or the radio frequency receiving unit) (the interior of the RFIC of the radio frequency integrated transceiver) may include: at least one receiving port, a frequency detection unit, a control unit, a plurality of signal processing paths, and a switch module, wherein the number of receiving ports in FIG. 8 is three and each receiving port is capable of receiving the full bandwidth signal, and the radio frequency transceiver of FIG. 8 further includes peripheral circuitry, wherein the peripheral circuitry includes one or more “full bandwidth receiving antennas” (ANT1 to ANT3), where each of the full bandwidth receiving antennas is configured for receiving the wireless signal having any frequency within the full bandwidth. Each receiving port within the radio frequency receiving unit 400a may be connected to one or more of the full bandwidth receiving antennas to receive the full bandwidth signal. It is illustrated that each receiving port is connected to one full bandwidth receiving antenna in FIG. 8 as an example.

In the radio frequency receiving unit of the present disclosure as described above, each receiving port may realize the reception of the full bandwidth signal, and the selection and configuration of the receiving ports are more flexible. Since it is no longer necessary that each receiving port can only receive the signal of a fixed frequency band, the design complexity of the radio frequency front-end and insertion loss of the path are reduced, and the reception capability of the radio frequency path is improved. In addition, the radio frequency receiving unit of the present disclosure may achieve the maximizing demand for CA/ENDC/NR CA by different operators in different regions of the world, improve downlink throughput and enhance user experience.

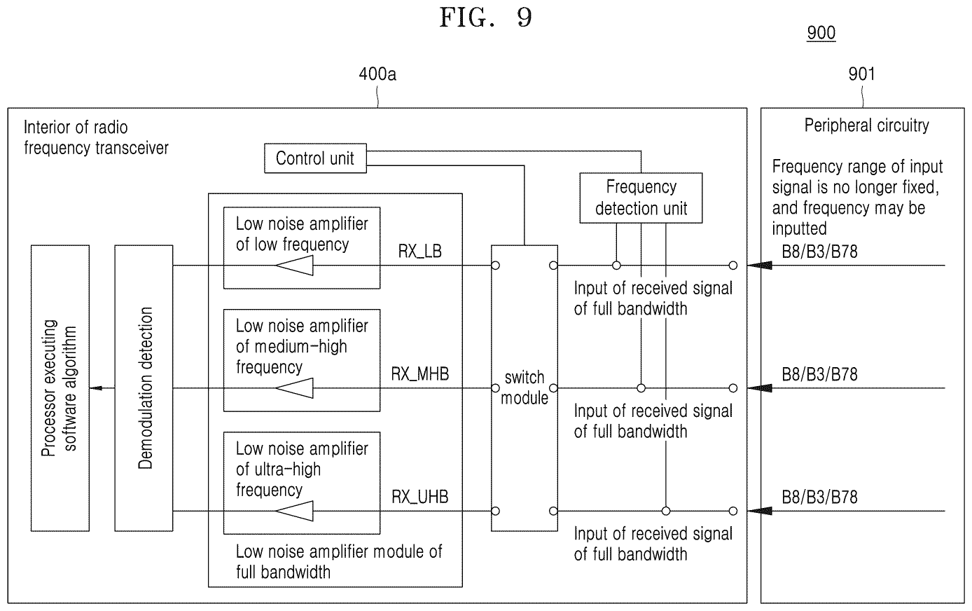

FIG. 9 illustrates signals being inputted to receiving ports of a radio frequency transceiver 900 with peripheral circuitry 901 in a carrier aggregation scenario according to embodiments of the present disclosure.

In the CA scenario, for example, in the case of carrier aggregation of frequency bands B8-B3-B78, each of the receiving ports of the radio frequency transceiver (or the radio frequency receiving unit 400a) in FIG. 9 may receive signal inputs of frequency bands B8/B3/B78. Compared to the prior art shown in FIG. 2, the frequency range of the input signal at the receiving port is no longer fixed. Each receiving port in FIG. 9 may realize the reception of the full bandwidth (full frequency band) signal, regardless of the low frequency, the medium-high frequency, or the ultra-high frequency may be input through the same receiving port. This realizes the flexible design of the peripheral circuitry, more flexible PCB wiring, the reduction of the insertion loss and improvement of the performance of the link. Moreover, the radio frequency transceiver in FIG. 9 may also realize the flexible configuration of CA/ENDC combinations, for example, CA: B8-B3-B7, frequency bands B8/B3/B7 (wherein the range of the frequency band B7 is 2620 MHz-2690 MHz) may be input to any one of the receiving ports of the radio frequency transceiver, and no longer needs to be input through the fixed receiving port, which flexibly realizes the free configuration of the receiving port.

Further, due to the limitation of the number of hardware receiving (Rx) ports, many CA scenarios are difficult to be realized in the prior art in which the frequency band of the receiving port is fixed. For example, in the case that the radio frequency transceiver includes four receiving ports and only one of them is the receiving port of the medium frequency, the CA scenario is difficult to be realized if there are two medium frequency signals in this CA scenario. According to embodiments of the present disclosure, the receiving port is capable of receiving the full bandwidth signal and the frequency band of the input signal of which is no longer fixed, and any two of the four receiving ports may be used to receive the medium frequency signals if the processing capacity of the subsequent signal processing paths is sufficient, thereby maximizing the realization of various CA scenarios, and improving the downlink throughput and enhancing the user experience. The sufficient processing capability of the subsequent signal processing paths herein means that the subsequent signal processing paths include two or more signal processing paths that may process the medium frequency signals.

It should be understood that the CA configurations and number of receiving ports herein are only examples and the present disclosure is not limited thereto.

In addition, compared to the design scheme in FIG. 3 of adding a switch module to the periphery of the radio frequency transceiver and switching to different receiving paths (which may include a filter module and a receiving unit) for different frequency bands in the periphery, embodiments of the present disclosure changes the circuit architecture inside the radio frequency transceiver (or the radio frequency receiving unit), and adds a frequency detection unit, in which the radio frequency signals of whichever frequency band of second-generation (2G)/third-generation (3G)/fourth-generation (4G)/fifth-generation (5G) or fifth-generation (5G) coming in, first passes the frequency detection unit to perform frequency detection to determine which frequency band the signal is within, and then be switched to the corresponding low noise amplifier for processing through control of the control unit. Here, the interior of the radio frequency transceiver may refer to the interior of a chip (e.g., a chip of the radio frequency transceiver), and the receiving port may refer to a connection point of the chip connected to an antenna feed. The technical solution of the present disclosure has the following advantages that: 1) the architecture is simple, and only the frequency detection unit and the like are added, which greatly reduces the cost in comparison; 2) each receiving port of the radio frequency transceiver is capable of realizing the reception of the full bandwidth signal; 3) the antenna scheme is flexible in design, and part of the frequency band may also be realized; and 4) the peripheral circuitry is simple, which reduces the complexity of the peripheral circuitry scheme, reduces the cost, improves the performance and enhances the user experience.

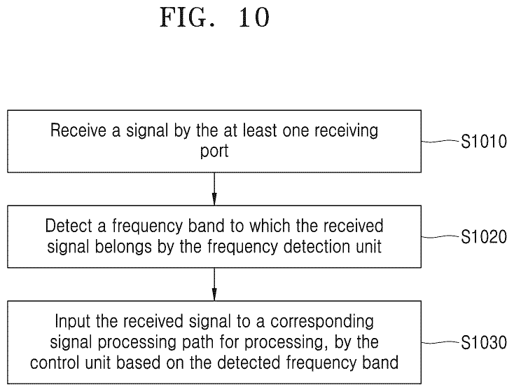

FIG. 10 illustrates a flowchart of a method of signal reception according to embodiments of the present disclosure.

The method of signal reception according to embodiments of the present disclosure may be applied to a radio frequency receiving unit, the radio frequency receiving unit may include a plurality of signal processing paths, at least one receiving port, a frequency detection unit, and a control unit, wherein each of the at least one receiving port is capable of receiving a full bandwidth signal.

In operation S1010, a signal is received by the at least one receiving port.

According to embodiments of the present disclosure, the radio frequency receiving unit may further include peripheral circuitry which includes one or more full bandwidth receiving antennas, wherein each of the at least one receiving port is connected to the one or more full bandwidth receiving antennas to receive the full bandwidth signal.

In operation S1020, a frequency band to which the received signal belongs is detected by the frequency detection unit.

According to embodiments of the present disclosure, the method of signal reception may further include: transmitting, by the frequency detection unit, the detected frequency band to the control unit.

In operation S1030, the received signal is inputted to a corresponding signal processing path for processing, by the control unit based on the detected frequency band.

According to embodiments of the present disclosure, the radio frequency receiving unit may further include a switch module, wherein the inputting of the received signal to the corresponding signal processing path for processing, by the control unit based on the detected frequency band, includes: receiving the detected frequency band transmitted by the frequency detection unit, and controlling, based on the detected frequency band, the switch module to switch the received signal to the signal processing path corresponding to the frequency band for processing.

According to embodiments of the present disclosure, the radio frequency receiving unit may further include a low noise amplifier module of full bandwidth which includes low noise amplifiers of different frequency bands, wherein each of the plurality of the signal processing paths is provided with a low noise amplifier corresponding to at least one frequency band.

According to embodiments of the present disclosure, wherein the inputting of the received signal to the corresponding signal processing path for processing, by the control unit based on the detected frequency band, may include: inputting, based on the detected frequency band, the received signal to the signal processing path provided with the low noise amplifier corresponding to the frequency band for processing.

According to embodiments of the present disclosure, the inputting, based on the detected frequency band, the received signal to the signal processing path provided with the low noise amplifier corresponding to the frequency band for processing may include: inputting the received signal to the signal processing path of low frequency provided with the low noise amplifier of the low frequency for processing in response to the detected frequency band being the low frequency, inputting the received signal to the signal processing path of medium-high frequency provided with the low noise amplifier of the medium-high frequency for processing in response to the detected frequency band being the medium-high frequency, and inputting the received signal to the signal processing path of ultra-high frequency provided with the low noise amplifier of the ultra-high frequency for processing in response to the detected frequency band being the ultra-high frequency.

In the signal receiving method of the present disclosure as described above, each receiving port of the radio frequency receiving unit may realize the reception of the full bandwidth signal, and the selection and configuration of the receiving port are more flexible. Since it is no longer that each receiving port can only receive the signal of a fixed frequency band, the design complexity of the radio frequency front-end and insertion loss of the path are reduced, and the reception capability of the radio frequency path is improved. In addition, the radio frequency receiving unit of the present disclosure may achieve the maximizing demand for CA/ENDC/NR CA by different operators in different regions of the world, improve downlink throughput and enhance user experience.

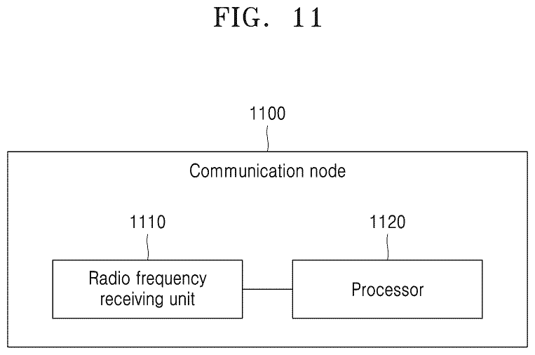

FIG. 11 illustrates a block diagram of a communication node according to example embodiments of the present disclosure. Referring to FIG. 11, the communication node 1100 may include a radio frequency receiving unit 1110 and a processor 1120, wherein the processor 1120 is coupled to the radio frequency receiving unit 1110 and configured to perform a method of signal reception according to the present disclosure. The communication node may be a node that includes a radio frequency transceiver and a processor, wherein the radio frequency transceiver includes the radio frequency receiving unit (i.e., the radio frequency receiver). According to embodiments, the communication node may be a terminal, a base station, and the like, as long as it is a node with the communication function.

According to embodiments of the disclosure, a computer-readable storage medium may also be provided, wherein a computer program is stored thereon, the program when executed may implement the method of signal reception according to the present disclosure. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD−R, CD+R, CD−RW, CD+RW, DVD-ROM, DVD−R, DVD+R, DVD−RW, DVD+RW, DVD-RAM, BD-ROM, BD-R, BD-R LTH, BD-RE, Blu-ray or optical disk memory, hard disk drive (HDD), solid state drive (SSD), card-based memory (such as, multimedia cards, Secure Digital (SD) cards or Extreme Digital (XD) cards), magnetic tapes, floppy disks, magneto-optical data storage devices, optical data storage devices, hard disks, solid state disks, and any other device, where the other device is configured to store the computer programs and any associated data, data files, and data structures in a non-transitory manner and to provide the computer programs and any associated data, data files, and data structures to a processor or computer, so that the processor or computer may execute the computer program. The computer program in the computer readable storage medium may run in an environment deployed in a computer device such as a terminal, client, host, agent, server, etc., and furthermore, in one example, the computer program and any associated data, data files and data structures are distributed on a networked computer system such that the computer program and any associated data, data files and data structures are stored, accessed, and executed in a distributed manner by one or more processors or computers.

In the radio frequency receiving unit and the method of signal reception thereof of the present disclosure as described above, each receiving port of the radio frequency receiving unit may realize the reception of the full bandwidth signal, and the selection and configuration of the receiving port are more flexible. Since it is no longer that each receiving port can only receive the signal of a fixed frequency band, the design complexity of the radio frequency front-end and insertion loss of the path are reduced, and the reception capability of the radio frequency path is improved. In addition, the radio frequency receiving unit of the present disclosure may achieve the maximizing demand for CA/ENDC/NR CA by different operators in different regions of the world, improve downlink throughput and enhance user experience.

Other embodiments of the disclosure will readily come to the mind of those skilled in the art upon consideration of the specification and practice of the inventive concepts disclosed herein. This application is intended to cover any variations, uses, or adaptations of the present disclosure that follow the general principles of the disclosure and include commonly known or customary technical means in the art that are not disclosed herein. Embodiments provided in the specification are merely examples, and the scope and spirit of the disclosure is indicated by the following claims.

It is to be understood that the disclosure is not limited to the precise structure already described above and illustrated in the accompanying drawings, and that various modifications and changes may be made without departing from its scope. The scope of the present disclosure is limited only by the appended claims.

What is claimed is:

1. A radio frequency receiving unit, comprising:
a plurality of signal processing paths;
at least one receiving port, each of the at least one receiving port being configured to receive a received signal having any frequency within a full bandwidth encompassing a predetermined range of frequencies;
a frequency detection unit configured to detect a frequency band, within the full bandwidth, to which the received signal received by the at least one receiving port belongs; and
a control unit configured to control, based on the detected frequency band, routing of the received signal to a corresponding signal processing path among the plurality of signal processing paths for processing.

2. The radio frequency receiving unit of claim 1, wherein the frequency detection unit is configured to indicate the detected frequency band to the control unit.

3. The radio frequency receiving unit of claim 2, wherein the radio frequency receiving unit further comprises a switch module,
wherein the control unit is configured to:
receive the detected frequency band indication from the frequency detection unit; and
control, based on the detected frequency band, the switch module to switch the received signal to the corresponding signal processing path for processing.

4. The radio frequency receiving unit of claim 1, wherein the radio frequency receiving unit further comprises a low noise amplifier module, configured for operation over the full bandwidth, which comprises low noise amplifiers optimized for different respective frequency bands,
wherein each of the plurality of the signal processing paths is provided with a low noise amplifier corresponding to at least one of the frequency bands.

5. The radio frequency receiving unit of claim 4, wherein the control unit is configured to:
control routing, based on the detected frequency band, of the received signal to the signal processing path provided with the low noise amplifier corresponding to the frequency band for processing.

6. The radio frequency receiving unit of claim 1, wherein the radio frequency receiving unit further comprises peripheral circuitry which comprises one or more full bandwidth receiving antennas,
wherein each of the at least one receiving port is connected to the one or more full bandwidth receiving antennas to receive the received signal.

7. A method of signal reception, performed by a radio frequency receiving unit, the radio frequency receiving unit comprising: a plurality of signal processing paths, at least one receiving port each configured to receive a received signal having any frequency within a full bandwidth encompassing a predetermined range of frequencies, a frequency detection unit and a control unit, the method comprising:
receiving, by the at least one receiving port, the received signal;
detecting, by the frequency detection unit, a frequency band to which the received signal belongs; and
routing the received signal to a corresponding signal processing path for processing, under control of the control unit, based on the detected frequency band.

8. The method of signal reception of claim 7, wherein the method further comprises:
indicating, by the frequency detection unit, the detected frequency band to the control unit.

9. The method of signal reception of claim 8, wherein the radio frequency receiving unit further comprises a switch module,
wherein the routing of the received signal to the corresponding signal processing path for processing, based on the detected frequency band, comprises:
receiving the indication of the detected frequency band from the frequency detection unit; and
controlling, based on the detected frequency band, the switch module to switch the received signal to the signal processing path corresponding to the detected frequency band for processing.

10. The method of signal reception of claim 7, wherein the radio frequency receiving unit further comprises a low noise amplifier module, configured for operation over the full bandwidth, which comprises low noise amplifiers optimized for different frequency bands,
wherein each of the plurality of the signal processing paths is provided with a low noise amplifier corresponding to at least one of the frequency bands.

11. The method of signal reception of claim 10, wherein the routing of the received signal to the corresponding signal processing path for processing, based on the detected frequency band, comprises:
routing, based on the detected frequency band, the received signal to the signal processing path provided with the low noise amplifier corresponding to the frequency band for processing.

12. The method of signal reception of claim 7, wherein the radio frequency receiving unit further comprises peripheral circuitry which comprises one or more full bandwidth receiving antennas,
wherein each of the at least one receiving port is connected to the one or more full bandwidth receiving antennas to receive the received signal.

13. A computer-readable storage medium, wherein a computer program is stored thereon, the program when executed causing a radio frequency receiving unit to implement a method, the radio frequency receiving unit comprising a plurality of signal processing paths, at least one receiving port each configured to receive a full bandwidth signal, a frequency detection unit, and a control unit, the method comprising:
receiving, by the at least one receiving port, a received signal;
detecting, by the frequency detection unit, a frequency band to which the received signal belongs; and
controlling routing of the received signal to a corresponding signal processing path for processing, by the control unit based on the detected frequency band a method.
